(19) United States
(12) Patent Application Publication
(10) Pub. No.: US 2016/0314493 A1
(43) Pub. Date: Oct. 27, 2016

(54) METRIC MONITORING IN SOCIAL ADVERTISING

(71) Applicant: Kenshoo Ltd., Tel Aviv (IL)

(72) Inventor: Roy UDASSIN, Givatayim (IL)

(21) Appl. No.: 15/138,111

(22) Filed: Apr. 25, 2016

Related U.S. Application Data
(60) Provisional application No. 62/152,059, filed on Apr. 24, 2015.

(51) Int. Cl. G06Q 30/02; G06Q 50/00

(52) U.S. Cl. CPC G06Q 30/0254; G06Q 50/01

(57) ABSTRACT

A method for changing targeting criteria in a social advertising platform. The method includes receiving data from a user. The data comprises one or more social metric rules, and targeting criteria values of one or more ad entities in a social advertising platform. The method comprises retrieving, automatically, from the social advertising platform, one or more baseline social metrics based on the targeting criteria values. The method includes periodically retrieving, automatically, respective present social metrics from the social advertising platform. The method includes periodically computing, automatically, a compliance value based on the present social metrics, the baseline social metrics, and the social metric rule(s). The method includes periodically comparing the compliance value to a predefined threshold and based on the comparison, instructing the social advertising platform to change one or more of the targeting criteria values. The method includes storing the changed targeting criteria values.

### CROSS REFERENCE TO RELATED APPLICATIONS

This application claims the benefit of U.S. Provisional Patent Application No. 62/152,059, filed Apr. 24, 2015, and entitled “Metric Monitoring in Social Advertising”, which is incorporated herein by reference in its entirety.

### FIELD OF THE INVENTION

The invention relates to the field of online advertising technology.

### BACKGROUND

Advertising using traditional media, such as television, radio, newspapers and magazines, is well known. Unfortunately, even when armed with demographic studies and entirely reasonable assumptions about the typical audience of various media outlets, advertisers recognize that much of their advertising budget is oftentimes simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their advertisements (also “ads”) to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords® advertising system by Google® Inc. of Mountain View, Calif., delivers ads targeted to keywords from search queries. Similarly, content-targeted ad delivery systems have been proposed. For example, U.S. Pat. No. 7,716,161 to Dean et al. and U.S. Pat. No. 7,136,875 to Anderson et al. describe methods and apparatuses for serving ads relevant to the content of a document, such as a web page. Content-targeted ad delivery systems, such as the AdSense advertising system by Google® for example, have been used to serve ads on web pages.

AdSense is part of what is often called advertisement syndication, which allows advertisers to extend their marketing reach by distributing advertisements to additional partners. For example, third party online publishers can place an advertiser's text or image advertisements on web pages that have content related to the advertisement. This is often referred to as “contextual advertising”. As the users are likely interested in the particular content on the publisher web page, they are also likely to be interested in the product or service featured in the advertisement. Accordingly, such targeted advertisement placement can help drive online customers to the advertiser's website.

Optimal ad placement has become a critical competitive advantage in the Internet advertising business. Consumers are spending an ever-increasing amount of time online, looking for information. The information, provided by Internet content providers, is viewed on a page-by-page basis. Each page can contain written and graphical information as well as one or more ads. Key advantages of the Internet, relative to other information media, are that each page can be customized to fit a customer profile and ads can contain links to other Internet pages. Thus, ads can be directly targeted at different customer segments. For example, ad targeting is nowadays possible based on the geographic location of the advertiser and/or the customer, the past navigation path of the customer outside or within the web site, the language used by the visitor's web browser, the purchase history on a website, the behavioral intent influenced by the user's action on the site, and more.

Furthermore, the ads themselves are often designed and positioned to form direct connections to well-designed Internet pages. The concept referred to as “native advertising” offers ads which more naturally blend into a page's design, in cases where advertiser's intent is to make the paid advertising feel less intrusive and, therefore, increase the likelihood users will click on it.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method for monitoring an ad entity in a social advertising platform, the method comprising using one or more hardware processors for: receiving data which characterizes (a) one or more targeting criteria of an ad entity in a social advertising platform, and (b) one or more baseline social metrics associated with the one or more targeting criteria; periodically interfacing with a social advertising platform, to check for one or more present social metrics for the one or more targeting criteria; and determining whether the one or more present social metrics are different from the one or more baseline social metrics.

Optionally, the method further comprises using the hardware processor(s) for providing a report based on the determining of whether the one or more present social metrics are different from the one or more baseline social metrics.

Optionally, the method further comprises using the hardware processor(s) for performing an action in the social advertising platform based on the determining of whether the one or more present social metrics are different from the one or more baseline social metrics.

There is provided, in accordance with an embodiment, a method for changing targeting criteria in a social advertising platform, the method comprising using hardware processor(s) for receiving data from a user. The data comprises one or more social metric rules, and targeting criteria values of one or more ad entities in a social advertising platform. The hardware processor(s) may further be used for retrieving, automatically, from the social advertising platform, one or more baseline social metrics based on the targeting criteria values. The hardware processor(s) may further be used for periodically retrieving, automatically, respective present social metrics from the social advertising platform. The hardware processor(s) may further be used for periodically computing, automatically, a compliance value based on the present social metrics, the baseline social metrics, and the social metric rule(s). The hardware processor(s) may further be used for periodically comparing the compliance value to a predefined threshold. The hardware processor(s) may further be used for periodically based on the comparison, sending one or more instructions to the social advertising platform, wherein the instruction(s) change one or more of the targeting criteria values. The hardware processor(s) may further be used for storing the changed targeting criteria values.

Optionally, the method further comprises using the hardware processor(s) for sending a notification of the changed targeting criteria values to the user.

Optionally, the method further comprises using the hardware processor(s) for providing a report based on the determining of whether the one or more present social metrics are different from the one or more baseline social metrics.

Optionally, the method further comprises using the hardware processor(s) for updating the baseline social metric(s) based on the changed targeting criteria values.

Optionally, the periodically performing is performed repeatedly at a time period of less than one minute until the compliance value complies with the predefined threshold to optimize the targeting criteria values according to one or more optimization from a group comprising an optimization method, an optimization algorithm, a Newton-Raphson method, and a heuristic.

Optionally, the periodically performing is executed by the hardware processor(s) at a time period greater than one hour.

Optionally, the social metrics are broken down for each of the targeting criteria values.

There is provided, in accordance with an embodiment, a computer program product for changing targeting criteria in a social advertising platform comprising a non-transitory computer-readable storage medium having program code embodied therewith. The program code may be executable by hardware processor(s) to receive data from a user, the data comprising social metric rule(s), and targeting criteria values of ad entities in a social advertising platform. The program code may be executable by hardware processor(s) to retrieve, automatically, from the social advertising platform, baseline social metric(s) based on the targeting criteria values. The program code may be executable by hardware processor(s) to periodically retrieve, automatically, respective present social metric(s) from the social advertising platform. The program code may be executable by hardware processor(s) to periodically compute, automatically, a compliance value based on the present social metrics, the baseline social metrics, and the social metric rule(s). The program code may be executable by hardware processor(s) to periodically compare the compliance value to a predefined threshold. The program code may be executable by hardware processor(s) to periodically based on the comparison, send instruction(s) to the social advertising platform, wherein the instruction(s) changes of the targeting criteria value(s). The program code may be executable by hardware processor(s) to store the changed targeting criteria values.

Optionally, the computer program product further comprises program code for sending a notification of the changed targeting criteria values to the user.

Optionally, the computer program product further comprises program code for providing a report based on the determining of whether the one or more present social metrics are different from the one or more baseline social metrics.

Optionally, the computer program product further comprises program code for updating the baseline social metric(s) based on the changed targeting criteria values.

Optionally, the periodically performing is performed repeatedly at a time period of less than one minute until the compliance value complies with the predefined threshold to optimize the targeting criteria values according to optimization(s) from a group comprising an optimization method, an optimization algorithm, a Newton-Raphson method, and a heuristic.

Optionally, the periodically performing is executed by the hardware processor(s) at a time period greater than one hour.

Optionally, the social metrics are broken down for each of the targeting criteria values.

There is provided, in accordance with an embodiment, a computerized system for changing targeting criteria in a social advertising platform. The computerized system comprises a non-transitory computer-readable storage medium having stored thereon program code. The program code comprises processor instructions for receiving data from a user, the data comprising social metric rule(s), and targeting criteria values of ad entities in a social advertising platform. The program code comprises processor instructions for retrieving, automatically, from the social advertising platform, baseline social metric(s) based on the targeting criteria values. The program code comprises processor instructions for periodically performing the action of retrieving, automatically, respective present social metric(s) from the social advertising platform. The program code comprises processor instructions for periodically performing the action of computing, automatically, a compliance value based on the present social metrics, the baseline social metrics, and the social metric rule(s). The program code comprises processor instructions for periodically performing the action of comparing the compliance value to a predefined threshold. The program code comprises processor instructions for periodically performing the action of, based on the comparison, sending instruction(s) to the social advertising platform, wherein the instruction(s) changes one or more of the targeting criteria values. The program code comprises processor instructions for storing the changed targeting criteria values. The computerized system comprises hardware processor(s) configured to execute the program code.

Optionally, the computerized system further comprises program code for sending a notification of the changed targeting criteria values to the user.

Optionally, the computerized system further comprises program code for providing a report based on the determining of whether the one or more present social metrics are different from the one or more baseline social metrics.

Optionally, the computerized system further comprises program code for updating the baseline social metric(s) based on the changed targeting criteria values.

Optionally, the periodically performing is performed repeatedly at a time period of less than one minute until the compliance value complies with the predefined threshold to optimize the targeting criteria values according to optimization(s) from a group comprising an optimization method, an optimization algorithm, a Newton-Raphson method, and a heuristic.

Optionally, the periodically performing is executed by the hardware processor(s) at a time period greater than one hour.

Optionally, the social metrics are broken down for each of the targeting criteria values.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. It is intended that the embodiments and figures disclosed herein are to be considered illustrative rather than restrictive. The figures are listed below.

FIG. 1 shows a schematic of an exemplary a cloud computing node;

FIG. 2 shows an illustrative cloud computing environment;

FIG. 3 shows a set of functional abstraction layers provided by the cloud computing environment; and

FIG. 4 shows a flow chart of a method for monitoring an ad entity during its active phase in a social advertising platform.

### DETAILED DESCRIPTION

Disclosed herein is a method for monitoring an ad entity during its active phase in a social advertising platform. The monitoring may be aimed at identifying changes to one or more social metrics of the ad entity while it is active (also “running”) in the social advertising platform. Advantageously, the monitoring may provide an advertiser with useful insight as to the dynamics of the ad entity, and potentially allow the advertiser to alter or even halt the ad entity based on this insight.

### GLOSSARY

“Online advertising platform” (or simply “advertising platform”): This term, as referred to herein, may relate to a service offered by an advertising business to different advertisers. In the course of this service, the advertising business serves ads, on behalf of the advertisers, to Internet users. Each advertising platform usually services a large number of advertisers, who compete on advertising resources available through the platform. The competition is oftentimes carried out by conducting some form of an auction, where advertisers bid on advertising resources. The ads may be displayed (and/or otherwise presented) in various web sites which are affiliated with the advertising business (these web sites constituting what is often referred to as a “display network”) and/or in one or more web sites operated directly by the advertising business.

AdWords®, a service operated by Google®, Inc. of Mountain View, Calif., is a prominent example of an advertising platform. In AdWords®, advertisers can choose between displaying their ads in a display network and/or in Google® search engine; the former involves the subscription of web site operators (often called “publishers”) to Google® AdSense program, whereas the latter, often referred to as SEM (Search Engine Marketing), involves triggering the displaying of ads based on keywords entered by users in the search engine.

A further type of advertising platforms, commonly referred to as a “social” advertising platform, involves the displaying of ads to users of online social networks. An online social network is often defined as a set of dyadic connections between persons and/or organizations, enabling these entities to communicate over the Internet. In social advertising, both the advertisers and the users enjoy the fact that the displayed ads can be highly tailored to the users viewing them. This feature is enabled by way of analyzing various demographics and/or other parameters of the users (jointly referred to as “targeting criteria”)—parameters which are readily available in many advertising platforms of social networks and are usually provided by the users themselves. Facebook® Ads, operated by Facebook, Inc. of Menlo Park, Calif., is such an advertising platform. LinkedIn® Ads, by LinkedIn Corporation of Mountain View, Calif., is another. For example, Twitter® is a social advertising platform.

“Online ad entity” (or simply “ad entity”): This term, as referred to herein, may relate to an individual ad, or, alternatively, to a set of individual ads, run by an advertising platform. An individual ad, as referred to herein, may include an ad copy, which is the text, graphics and/or other media to be served (displayed and/or otherwise presented) to users. In addition, an individual ad may include and/or be associated with a set of parameters, such as searched keywords to target, geographies to target, demographics to target, a bid for utilization of advertising resources of the advertising platform, and/or the like. Sometimes, the bid may set for a particular parameter instead of or in addition to setting a global bid for the ad entity; for example, a bid may be per keyword, geography, etc.

To aid advertisers in neatly organizing their ads, advertising platforms often allow grouping individual ads in sets, such as the “AdGroups®” feature in Google® AdWords®. The advertiser may decide on the logic behind such grouping, but it is common to have ads grouped by similar ad copies, similar targeting, etc. Advertising platforms may allow an even more abstract way to group ads; this is often called a “campaign”. A campaign usually includes multiple sets of ads, with each set including multiple ads.

“Performance”: This term, as referred to herein with regard to an ad, may relate to various statistics gathered in the course of running the ad. A “running” phase of the ad may refer to a duration in which the ad was served to users, or at least to a duration during which the advertiser defined that the ad should be served. The term “performance” may also relate to an aggregate of various statistics gathered for a set of ads, a campaign, etc. The statistics may include multiple parameters (also “metrics”). Exemplary metrics are:
“Impressions”: the number of times the ad has been served to users;
“Reach”: the number of unique users who have been exposed to the ad. This differs from “impressions” in that the reach metric does not increase when the same user is exposed to the same ad multiple times, whereas the impressions metric does. The reach metric is very common in social advertising platforms;
“Frequency”: the number of times a certain user has been exposed to the same ad. This metric is very common in social advertising platforms;
“Clicks”: the number of times users clicked (or otherwise interacted with) the ad entity;
“Cost per click (CPC)”: the average cost of a click (or another interaction with an ad entity) to the advertiser;
“Cost per impression”: the average cost of an impression to the advertiser;
“Click-through rate (CTR)”: the ratio between clicks and impressions of the ad entity, namely—the number of clicks divided by the number of impressions;
“Conversions”: the number of times in which users who clicked (or otherwise interacted with) the ad entity and have consecutively accepted an offer made by the advertiser. For examples, users who purchased an advertised product, users who subscribed to an advertised service, or users who filled in their details in a lead generation form;
“Return on investment (ROI)” or “Return on advertising spending (ROAS)”: the ratio between the amount of revenue generated as a result of online advertising, and the amount of investment in those online advertising efforts. Namely—revenue divided by expenses;
“Revenue per click”: the average amount of revenue generated to the advertiser per click (or another interaction with an ad entity). This may be calculated as a function of the clicks, conversions and the advertiser's average revenue per conversion;
“Revenue per impression”: the average amount of revenue generated to the advertiser per impression of the ad entity. This may be calculated as a function of the impressions, conversions, and the advertiser's average revenue per conversion;

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in one or more embodiment of the present invention, Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

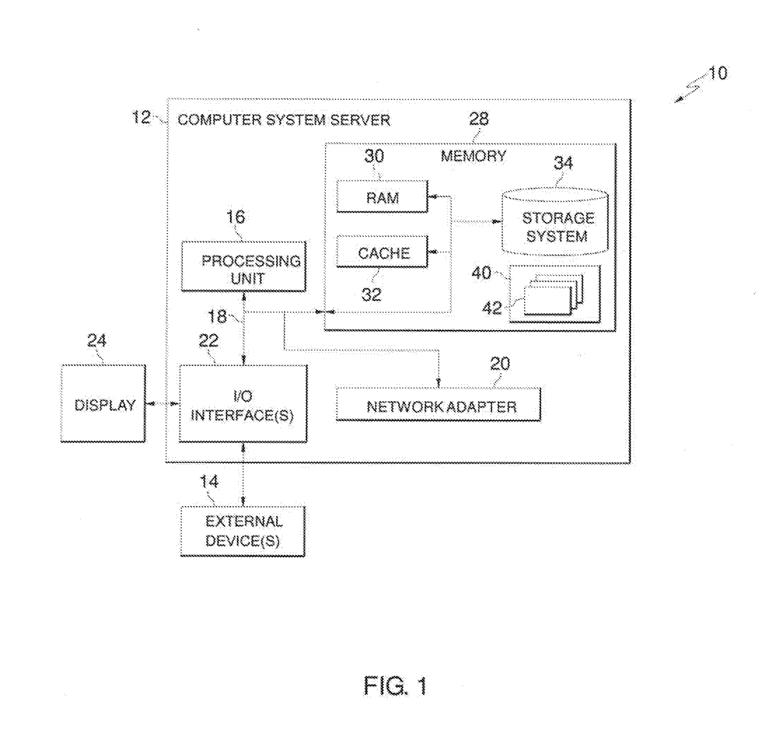

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system.

Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include one or more program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

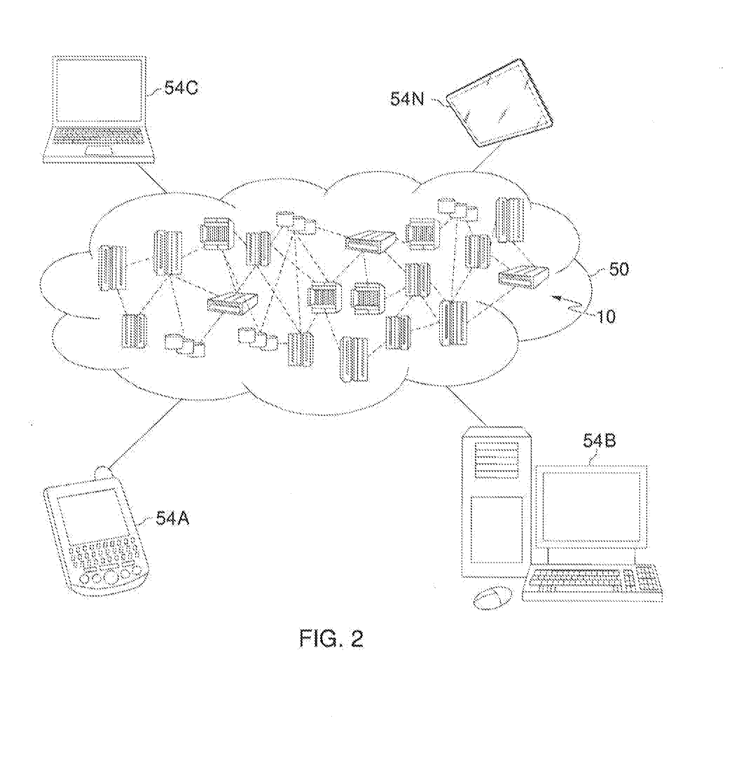

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or tablet computing device 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

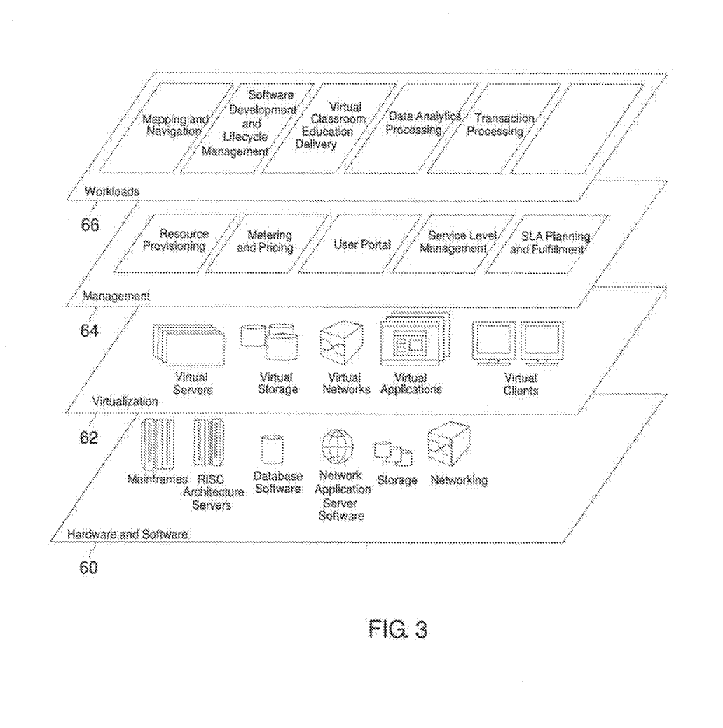

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided: Hardware and software layer 60 includes hardware and software components.

Examples of hardware components include mainframes, RISC (Reduced Instruction Set Computer) architecture based servers; storage devices; networks and networking components. Examples of software components include network application server software; and database software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; and data analytics processing; transaction processing.

As briefly discussed above, disclosed herein are methods for monitoring an ad entity during its active phase in a social advertising platform. The method may be implemented by a computer server, a computing platform, a computer program product, such as a software package, a computer, a cloud computing platform, a SaaS platform, and the like. For brevity, the term technique will be used herein to refer to all possible technical implementations, whether tangible or intangible, of the methods. The present techniques use computerized methods, to automatically monitor input values from an advertising platform, receive user rules that reflect a user's advertising goals, and automatically convert the input values and rules to actionable advertising platform instructions, so that the rules are maintained by the techniques over time.

The present techniques solve the problem of online advertising platform users using the automatic monitoring and conversions to translate human language goals to computer program code that when executed by one or more hardware processor, sends instructions to an online advertising platform to make changes to ad entity values, such as increase an ad entity bid value, add/delete/change an ad entity keyword, add/delete/change an ad entity targeting criteria, such as target demographic values, other parameter values, and/or the like. These changes can be made in real time without the need of the user manually monitoring the input values, and allows the techniques to use advanced optimizing algorithms, methods, heuristics, and/or the like, such as Newton-Raphson methods, machine learning algorithms, multimodal optimization methods, multi objective methods, and/or the like, to find the best ad entity values to change, and the direction to change them.

Optionally, heuristics are used to find the changes in ad entity target criteria required to maintain the rules, by trial and error changes to the targeting criteria. These ad entity value changes can be done in milliseconds by the hardware processor(s) instead of minutes or hours by a human manually. These ad entity value changes can be monitored over long periods of time, day and night to determine trends in the effects of changing the ad entity values on the input values used by the rules to determine if a user ad entity goal has been complied with.

The present techniques may be better understood by first explaining the common ad entity setup process in social advertising platforms. Initially, a user who sets up the ad entity may define one or more targeting criteria for the ad entity, which criteria is indicative of one or more classifications of users to which the ad entity is to be displayed. For simplicity of discussion, the following description relates to criteria in plural form; however, a single criterion is also intended herein.

Exemplary targeting criteria include:

1) User interests;

2) User behaviors;

3) User demographic parameters, such as age, gender, life events, political views, generation, family status, etc.;

4) User geographic parameters, such as country, state, city, language, etc.;

5) Users who are friends of another user, friends of friends of another user, etc.;

6) User education status, education history (such as major, college years), etc.; and

7) User work place, work position, etc.

This is not an exhaustive list, and any targeting criteria currently available in social advertising platforms, as well as any targeting criteria to be available in the future, are explicitly intended herein. The above list of targeting criteria may be implemented as values representing the various criteria.

Responsive to defining the targeting criteria, the social advertising platform may provide the user with one or more estimated social metrics associated with those criteria; namely, it may indicate to the user what is the relationship between the requested targeting criteria and the social metrics. This indication may be based on proprietary algorithms of the social advertising platform. The social metrics may include, for example, an estimated reach of the ad entity (namely, how many users it is expected to target), an estimated bid for serving the ad entity (for example, bid per click, bid per a number or impressions, etc.), estimated impression of the ad entity (for example, how many times it is expected that the ad entity will be viewed by users) and/or the like. The estimated social metrics are optionally broken down per targeting criterion. For example, the social advertising platform may display to the user the estimated reach per each targeting criterion. The user may then conclude the setup process, and instruct the social advertising platform to start running the ad entity based on the one or more targeting criteria and one or more social metrics.

For example, a user selects an ad entity, an advertising platform from the display of a client terminal. For example, the user is allowed to build a set of rules relating to the social metrics that achieve the user goals, such as increase reach, increase reach while maintaining impressions, decrease CPC while maintaining reach, and/or the like. For example, a hardware processor receives the ad entity, platform, and rules, and converts these to program code that may be sent to the platform to receive an initial set of social metrics associated with the platform, ad entity, rules, targeting criteria, and the like.

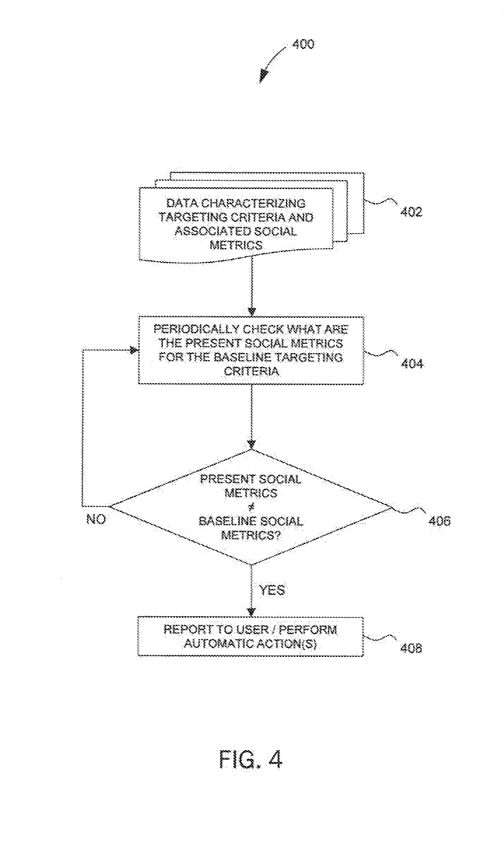

Following the conclusion of the setup process, the present techniques may be set in motion. Reference is now made to FIG. 4, which shows a flow chart of a method 400 for monitoring an ad entity during its active phase in a social advertising platform, in accordance with some embodiments.

In a step 402, data which characterizes the targeting criteria and their associated social metrics may be received. These data may include the targeting criteria and their associated social metrics as existing during the setup phase of the ad entity. Accordingly, these social metrics may be referred to as the “baseline social metrics”. The receipt of these data may be manual, e.g. provided by a user, or automatic, e.g. fetched automatically from the social advertising platform, such as through an Application Program Interface (API) of that platform.

For example, a user may initiate a retrieval of social metrics by clicking a button on the display. For example, a countdown timer reaching zero may initiate a retrieval of social metrics. The retrieval may be performed using an API and/or a software development kit (SDK) provided by the platform. For example, a Facebook® social advertising platform uses a PHP SDK, a Python SDK, a Java SDK, an HTTP-based API, and/or the like. The social metrics may be received by sending an API computer program command and/or instruction to the advertising platform and receiving in response a set of social metric values. These may be initial social metric values or monitored social metric values.

In a step 404, an automatic monitoring agent may be executed, to periodically interface with the social advertising platform and check what are the present social metrics for the targeting criteria. The periodicity may be, for instance, of intervals ranging from minutes, hours, or even days. The automatic monitoring agent, as an example, may utilize an API of the social advertising platform for submitting a query which includes the baseline targeting criteria, and receiving a response which includes the present social metrics associated with those baseline targeting criteria. An example of such API is the one available for the Facebook® Ads social advertising platform, at https://developers.facebook.com/docs/reference/ads-api/reachestimate. This web page, as viewed on Apr. 13, 2014, is incorporated herein by reference in its entirety. It describes an API to fetch various social metrics, namely “users”, “bid estimations” and “imp_estimates”, for given targeting criteria (referred to as “targeting specs”).

For example, the following program code executed by hardware processor(s) can retrieve the social metrics:

```
var adsUtil = {
  getOptimizationGoalByObjective: function(objective) {
  // Decide possible optimization goals based on objective
  // Ref: https://developers.facebook.com/docs/marketing-api/
  validation/v2.4
  var optimizationGoal = [
  [‘NONE’, ‘No Optimization Goal’],
  ];
  if (objective === ‘WEBSITE_CONVERSIONS’) {
  optimizationGoal = [
    [‘OFFSITE_CONVERSIONS’, ‘Offsite Coversion’],
    [‘IMPRESSIONS’, ‘Impressions’],
    [‘LINK_CLICKS’, ‘Clicks on Links’],
    [‘POST_ENGAGEMENT’, ‘Post Engaements’],
    [‘REACH’, ‘Number of Reaches’],
  ];
  } else if (objective === ‘POST_ENGAGEMENT’) {
  optimizationGoal = [
    [‘POST_ENGAGEMENT’, ‘Post Engaements’],
    [‘IMPRESSIONS’, ‘Impressions’],
    [‘LINK_CLICKS’, ‘Clicks on Links’],
    [‘REACH’, ‘Number of Reaches’],
    [‘VIDEO_VIEWS’, ‘Video Views’],
  ];
  } else if (objective === ‘MOBILE_APP_INSTALLS’) {
  optimizationGoal = [
    [‘APP_INSTALLS’, ‘App Installs’],
    [‘LINK_CLICKS’, ‘Clicks on Links’],
    [‘IMPRESSSIONS’, ‘Impresssion’],
    [‘REACH’, ‘Number of Reaches’],
  ];
  }
  return optimizationGoal;
  },
  getBillingEventByOptimizationGoal: function(optimizationGoal) {
  // Decide possible billing events based on optimization goal
  // Ref: https://developers.facebook.com/docs/marketing-api/
  validation/v2.4
  var billingEvent = [
  [‘IMPRESSIONS’, ‘Impressions’],
  ];
  if (optimizationGoal === ‘APP_INSTALLS’) {
  // Remove this event as it does not work with autobid
  // billingEvent.push([‘APP_INSTALLS’, ‘App Installs’]);
  } else if (optimizationGoal === ‘LINK_CLICKS’) {
  billingEvent.push([‘LINK_CLICKS’, ‘Clicks on Links’]):
  } else if (optimizationGoal === ‘POST_ENGAGEMENT’) {
  billingEvent.push([‘POST_ENGAGEMENT’, ‘Post Engagements’]);
  }
  return billingEvent;
  },
};
module.exports = adsUtil;
```

In a decision block 406, it is determined whether the present social metrics are different from the baseline social metrics, or, if this is already the second or later iteration of step 404, whether the present social metrics are different from the social metrics received in a previous iteration of step 404. If no difference is detected, then step 404 is repeated. If a difference is detected, then method 400 may progress to a step 408. A difference may be predefined, for example, as a constant value of the social metrics, a deviation percentage (up or down), and/or the like. For example, a compliance value is computed based on the rule(s), baseline social metrics, and present social metrics, such as a value between zero and one, and the compliance values is compared to a threshold to determine if the rule is being complied with. After the automatic updating of the targeting criteria values, the updated baseline social metrics and the updated targeting criteria values may be stored on a non-transitory computer readable storage medium for use in the future monitoring cycles.

For example, a reach threshold is set to be maintained at 200,000 target users, and a monitored reach metric value is received of 198,734 target users, and the demographics are changed from “female users from age 20-35” to “female users from age 20-38” by sending API instructions to the advertising platform. Optionally, a notification is sent to the advertiser informing them of the updated target criterion, such as target demographics and the like.

In step 408, any detected change may be reported to a user and/or acted upon automatically or semi-automatically. Alternatively, the user may be allowed to preset a certain threshold, which, only if exceeded, a report is issued. The report to the user may be, for example, by transmitting a suitable electronic message to the user (e.g. an email, a push notification, etc.), by publishing a notification in a user-accessible web-based dashboard, etc. By way of example, the report may state that an estimated number of users reached by the baseline targeting criteria value has increased from 15,000 to 20,000, and that a bid estimation for the baseline targeting criteria value has decreased from $1.00 per click to $0.75 per click. The user may then elect to manually act upon the report, for example by transmitting suitable instructions to the social advertising platform. These instructions may include, for instance, an adjustment to the bid, a change to the definition of the targeting criteria, and/or the like.

For example, the following program code executed by hardware processor(s) updates an ad entity:

```
var React = require(‘react’);
var Router = require(‘react-router’);
var Bootstrap = require(‘react-bootstrap’),
  Row = Bootstrap.Row,
  Col = Bootstrap.Col,
  Input = Bootstrap.Input,
  Button = Bootstrap.Bution,
  Modal = Bootstrap.Modal;
var updateMixin = reuire(‘./updateMixin’);
var SelectInput = require(‘../components/react-bootstrap-select’);
var AdsConnectionObjects = require(‘../components/
adsConnectionObjects’);
var statuses = [
  ‘ACTIVE’, ‘PAUSED’
];
var adSetUpdate = React.createClass({
  mixins: [updateMixin],
  fields: [
  ‘name’, ‘status’, ‘creative’
  ],
  getInitialState: function( ) {
  return {
  canSave: false,
  };
  },
  saveValidate: function( ) {
  var canSave = false;
  if (this.state.isUpdate) {
  if (this.state.name !== ‘’){
    // cannot change to empty name
    canSave = (this.state.hasOwnProperty(‘name’) ||
    this.state.hasOwnProperty(‘status’) ||
    this.state.hasOwnProperty(‘creative’));
  }
  } else {
  canSave = (this.state.name &&
    this.state.hasOwnProperty(‘status’) &&
    this.state.hasOwnProperty(‘creative’));
  }
  if (canSave != this.state.canSave) {
  this.setState({canSave: canSave});
  }
},
loadTransform: function(store) {
  if (store.creative) {
  store.creative = JSON.stringify(store.creative);
  }
},
render: function( ) {
  return (
  <Modal {...this.props}
    title={(this.state.isUpdate?‘Edit’:‘Create’) + ‘ Ad’}>
    <div className=‘modal-body’>
    <Input type=‘text’ label=“Creative Spec”
    valueLink={this.linkData(‘creative’)}
    placeholder=‘Enter Creative Spec’/>
    <Row>
    <Col md={6}>
      <SelectInput label=‘Ad Status’ options={statuses}
      placeholder=‘Choose Status’
      valueLink={this.linkData(‘status’)}/>
    </Col>
    <Col md={6}>
      <Input type=‘text’ label=“Ad Name”
      valueLink={this.linkData(‘name’)}
      placeholder=‘Enter Ad Name’/>
    </Col>
    </Row>
    </div>
    <div className=“modal-footer”>
      {this.renderErrorMessage( )}
      <Button bsStyle=“primary” disabled={!this.state.canSave}
      onClick={this.saveData}>
      Save
      </Button>
    </div>
    </Modal>
  );
  },
});
module.exports = adSetUpdate;
```

Additionally or alternatively, the detected change may be acted upon automatically or semi-automatically by method 400. Namely, one or more instructions may be transmitted to the social advertising platform, either automatically or after receiving the consent of the user. These instructions may include, for instance, an adjustment to the bid, a change to the definition of the targeting criteria, and/or the like. To this end, method 400 may utilize a user-provided rule set, which lists change scenarios and their associated actions in the social advertising platform. For example, the rule set may dictate that an X percent change to a certain social metric should yield a Y percent change to a bid, where X and Y may be the same or different, and may bear the same or a different sign (i.e. minus or plus). As another example, the rule set may dictate that if the estimated reach drops below a certain threshold, then the ad entity should be stopped or paused from running. As yet another example, the rule set may change the structure of the campaign, its targeting (e.g. geo-location, age, etc.), etc. In any of the above scenarios, a rule set may automatically send a notification of the executed action to the advertiser.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for changing targeting criteria in a social advertising platform, the method comprising using at least one hardware processor for:
receiving data from a user, the data comprising:
(a) at least one social metric rule, and
(b) targeting criteria values of at least one ad entity in a social advertising platform;
retrieving, automatically, from said social advertising platform, at least one baseline social metric based on the targeting criteria values;
periodically performing the actions of:
(i) retrieving, automatically, respective at least one present social metric from the social advertising platform,
(ii) computing, automatically, a compliance value based on the present social metrics, the baseline social metrics, and the at least one social metric rule,
(iii) comparing said compliance value to a predefined threshold,
(iv) based on said comparison, sending at least one instruction to said social advertising platform, wherein the at least one instruction changes at least one of the targeting criteria values; and
storing said changed targeting criteria values.

2. The method according to claim 1, further comprising using the at least one hardware processor for sending a notification of said changed targeting criteria values to said user.

3. The method according to claim 1, further comprising using the at least one hardware processor for providing a report based on the determining of whether the one or more present social metrics are different from the one or more baseline social metrics.

4. The method according to claim 1, further comprising using the at least one hardware processor for updating the at least one baseline social metric based on said changed targeting criteria values.

5. The method according to claim 1, wherein said periodically performing is performed repeatedly at a time period of less than one minute until said compliance value complies with the predefined threshold to optimize the targeting criteria values according to at least one optimization from a group comprising an optimization method, an optimization algorithm, a Newton-Raphson method, and a heuristic.

6. The method according to claim 1, wherein said periodically performing is executed by said at least one hardware processor at a time period greater than one hour.

7. The method according to claim 1, wherein said social metrics are broken down for each of the targeting criteria values.

8. A computer program product for changing targeting criteria in a social advertising platform comprising a non-transitory computer-readable storage medium having program code embodied therewith, the program code being executable by at least one hardware processor to:
receive data from a user, the data comprising:
(a) at least one social metric rule, and
(b) targeting criteria values of at least one ad entity in a social advertising platform;
retrieve, automatically, from said social advertising platform, at least one baseline social metric based on the targeting criteria values;
periodically perform the actions of:
(i) retrieve, automatically, respective at least one present social metric from the social advertising platform,
(ii) compute, automatically, a compliance value based on the present social metrics, the baseline social metrics, and the at least one social metric rule,
(iii) compare said compliance value to a predefined threshold,
(iv) based on said comparison, send at least one instruction to said social advertising platform, wherein the at least one instruction changes at least one of the targeting criteria values; and
store said changed targeting criteria values.

9. The computer program product according to claim 8, further comprising program code for sending a notification of said changed targeting criteria values to said user.

10. The computer program product according to claim 8, further comprising program code for providing a report based on the determining of whether the one or more present social metrics are different from the one or more baseline social metrics.

11. The computer program product according to claim 8, further comprising program code for updating the at least one baseline social metric based on said changed targeting criteria values.

12. The computer program product according to claim 8, wherein said periodically performing is performed repeatedly at a time period of less than one minute until said compliance value complies with the predefined threshold to optimize the targeting criteria values according to at least one optimization from a group comprising an optimization method, an optimization algorithm, a Newton-Raphson method, and a heuristic.

13. The computer program product according to claim 8, wherein said periodically performing is executed by said at least one hardware processor at a time period greater than one hour.

14. The computer program product according to claim 8, wherein said social metrics are broken down for each of the targeting criteria values.

15. A computerized system for changing targeting criteria in a social advertising platform, the computerized system comprising:
(a) a non-transitory computer-readable storage medium having stored thereon program code for:
receiving data from a user, the data comprising:
at least one social metric rule, and
targeting criteria values of at least one ad entity in a social advertising platform;
retrieving, automatically, from said social advertising platform, at least one baseline social metric based on the targeting criteria values;
periodically performing the actions of:
retrieving, automatically, respective at least one present social metric from the social advertising platform,
computing, automatically, a compliance value based on the present social metrics, the baseline social metrics, and the at least one social metric rule,
comparing said compliance value to a predefined threshold,
based on said comparison, sending at least one instruction to said social advertising platform, wherein the at least one instruction changes at least one of the targeting criteria values;
storing said changed targeting criteria values; and
(b) at least one hardware processor configured to execute said program code.

16. The computerized system according to claim 15, further comprising program code for sending a notification of said changed targeting criteria values to said user.

17. The computerized system according to claim 15, further comprising program code for providing a report based on the determining of whether the one or more present social metrics are different from the one or more baseline social metrics.

18. The computerized system according to claim 15, further comprising program code for updating the at least one baseline social metric based on said changed targeting criteria values.

19. The computerized system according to claim 15, wherein said periodically performing is performed repeatedly at a time period of less than one minute until said compliance value complies with the predefined threshold to optimize the targeting criteria values according to at least one optimization from a group comprising an optimization method, an optimization algorithm, a Newton-Raphson method, and a heuristic.

20. The computerized system according to claim 15, wherein said periodically performing is executed by said at least one hardware processor at a time period greater than one hour.

21. The computerized system according to claim 15, wherein said social metrics are broken down for each of the targeting criteria values.
